(19) United States
(12) Patent Application Publication
(10) Pub. No.: US 2026/0309072 A1
(43) Pub. Date: Oct. 8, 2026

(54) SUPERCHARGING COMPRESSOR FOR AN INTERNAL COMBUSTION ENGINE

(71) Applicant: FERRARI S.P.A., Modena (MO) (IT)

(72) Inventors: Silvio RABBOLINI, Modena (MO) (IT); Pierre Alain HOFFER, Modena (MO) (IT); Vincenzo MAUCERI, Modena (MO) (IT)

(73) Assignee: FERRARI S.P.A., Modena (MO) (IT)

(21) Appl. No.: 19/636,297

(22) Filed: Apr. 1, 2026

(30) Foreign Application Priority Data
Apr. 2, 2025 (IT) 102025000006990

(51) Int. Cl. F02B 29/04

(52) U.S. Cl. CPC F02B 29/0481

(57) ABSTRACT

A supercharging compressor for an internal combustion engine has an inlet port, an outlet port, a support body and an impeller that is coupled to the support body so as to rotate about an axis and is configured so as to draw in air from the inlet port and compress this air towards the outlet port when subjected to rotation; the compressor also has a Peltier cell cooling device, arranged between the inlet port and the impeller and provided with at least one Peltier cell, which has two faces, opposite each other, and is fed by means of electrical wiring to generate a difference in temperature and, thus, a transfer of heat between these faces in order to cool the air at the inlet to the impeller.

### CROSS-REFERENCE TO RELATED APPLICATIONS

This patent application claims priority from Italian patent application no. 102025000006990 filed on Apr. 2, 2025, the entire disclosure of which is incorporated herein by reference.

### TECHNICAL FIELD

This invention relates to a supercharging compressor for an internal combustion engine, in particular for vehicle traction.

### BACKGROUND

In the field of vehicles with internal combustion engines, the latter may be supercharged, that is, supplied with combustive air that is compressed by means of a compressor, actuated by an electric motor, or by a turbine arranged along the exhaust gas line coming out of the engine.

Compression, as is well known, causes an increase in air temperature. This increase in temperature can be problematic, particularly with regard to the reduction in volumetric efficiency in the combustion chambers of internal combustion engines, when compressing the air inside them, and with regard to the risks of knocking in petrol thermal engines.

To overcome these drawbacks, as is well known, the combustive air coming out of the supercharging compressor is cooled by means of a heat exchanger, generally referred to as an “intercooler”.

For internal combustion engines having a high specific power output, intercoolers and supercharging compressors tend to have a large footprint, which can make space design in the vehicle engine compartment problematic.

Therefore, there is a need to refine the known solutions just described, even though they are widely used, in such a way that the size and/or mechanical power absorbed by the supercharging compressor can be reduced, and/or in such a way that the overall dimensions of this intercooler can be reduced.

To meet this requirement, some known solutions are configured to cool the combustive air via ducts that allow a coolant to circulate at an outlet area of the supercharging compressor.

This additional cooling tends to reduce the temperature rise due to compression and proves beneficial. For example, it makes it possible to reduce the heat exchange surface area required, at the intercooler, to cool the air after compression (and thus makes it possible to reduce the footprint of the intercooler itself) when the other operating parameters are the same (compressor size and power, compressor rotation speed, impeller structure, etc.); it makes it possible to increase engine performance, in terms of torque, power and responsiveness of the engine (also referred to as “turbo-lag”) during supercharging; moreover, with the same compressor geometry and the same engine performance, it makes it possible to reduce the speed of rotation of the compressor shaft.

However, known solutions of the type just described are unsatisfactory, as they achieve relatively little advantage in terms of temperature control, and are relatively complex to design and implement, due to the ducts and hydraulic connections required to make the coolant flow to the outlet of the supercharging compressor.

There is, therefore, a need for an alternative and improved solution to cool the air at the supercharging compressor.

The purpose of this invention is to provide a supercharging compressor for a vehicle internal combustion engine, which enables the above requirements to be fulfilled in a simple and/or economical and/or effective manner.

### SUMMARY

According to this invention, a supercharging compressor for a vehicle internal combustion engine is provided as defined in claim 1.

The dependent claims define preferred embodiments according to this invention.

### BRIEF DESCRIPTION OF THE DRAWINGS

In order to better understand this invention, a number of non-limiting embodiments thereof will now be described by way of example with reference to the attached drawings, in which:

FIG. 1 is a perspective view of a preferred embodiment of the supercharging compressor for a vehicle internal combustion engine according to this invention;

FIG. 2 shows the supercharging compressor, schematically and in a cutaway view, according to the cross-section plane indicated by line II-II in FIG. 1; and

FIG. 3 shows a detail of the supercharging compressor, on an enlarged scale and in cross section according to the cross-section plane indicated by the line III-III in FIG. 1.

### DESCRIPTION OF PREFERRED EMBODIMENTS

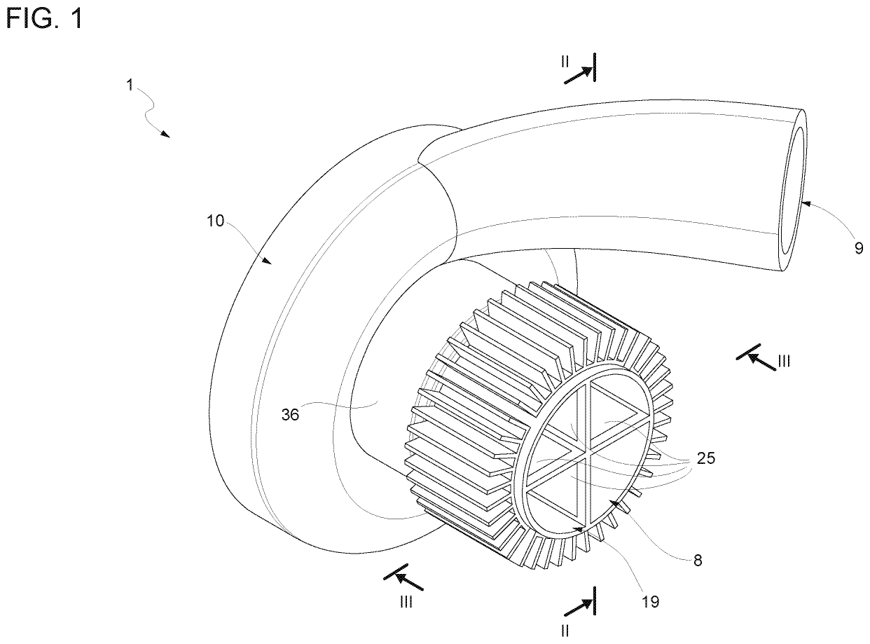

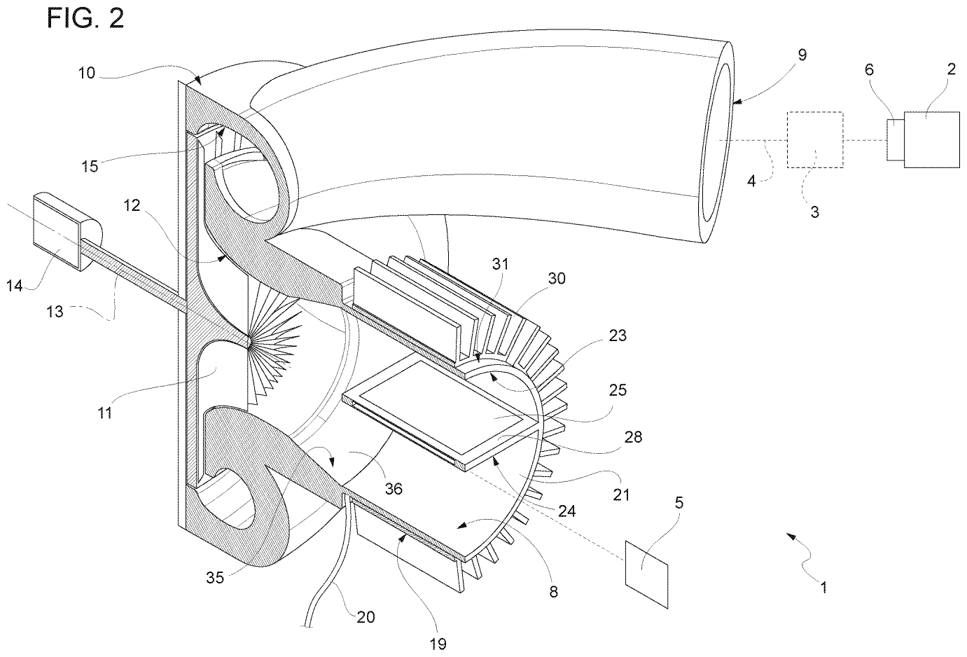

In FIG. 1, reference number 1 denotes a compressor used to supercharge combustive air in an internal combustion engine 2, illustrated schematically in FIG. 2. With reference to this figure, the compressor 1 is arranged upstream of a heat exchanger 3, usually referred to as an intercooler, along a supply line 4 that conveys combustive air from an external atmosphere through a suction port 5 and ends at an intake manifold 6 coupled to the engine 2. Specifically, the compressor 1 comprises an inlet port 8, connected to the suction port 5, and an outlet port 9 connected to an inlet of the heat exchanger 3. In particular, the compressor 1 comprises a support body 10 and an impeller 11 (schematically illustrated), which is arranged in a housing 12 of the body 10 in such a way that it can rotate about its axis 13, under the action of an actuation component 14 (schematically illustrated), which may be defined as a turbine driven by a flow of exhaust gases produced, in use, by the engine 2, or by an electric motor.

The impeller 11 has a known blade structure such that it draws air in from the inlet port 8 and compresses it towards the outlet port 9 when rotated about its axis 13. In particular, the compressor 1 is a centrifugal compressor, whereby the impeller 11 draws in air along the axis 13 and compresses it in a radial direction; for example, the outlet port 9 is arranged tangentially, at one end of a spiral 15 defined by the body 10 to progressively collect the air compressed by the impeller 11.

According to this invention, the compressor 1 comprises a Peltier cell cooling device, which is denoted by reference number 19, is arranged in an intermediate position between the inlet port 8 and the impeller 11 (considering the direction of the air flow), and is supplied by means of electrical wiring 20 (schematically illustrated) to cool the combustive air sucked in.

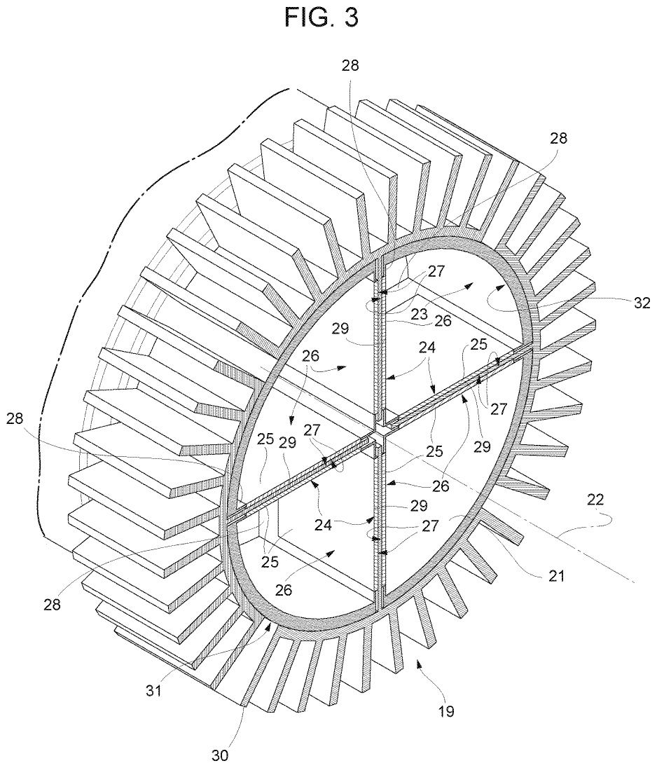

With reference to FIG. 3, the device 19 comprises a tubular body 21, which extends along an axis 22 and defines a passage 23 for the combustive air. In the particular example illustrated, the tubular body 21 is defined by four sectors, fixed with respect to each other.

The passage 23 is preferably engaged by one or more walls 24, which extend radially from the tubular body 21 with respect to the axis 22 and have, each, two outer faces which are opposite to each other and are exposed to the combustive air flowing in the passage 23.

In the attached figures, the walls 24 have a flat shape, but this should not be understood as a limiting feature; for example, they could alternatively have an airfoil. For example, the device 19 comprises four walls 24, spaced 90 ° apart from each other.

The device 19 comprises one or more Peltier cells 25, which are subjected, in use, to a potential difference by means of the electrical wiring 20, in a known way not illustrated in detail. Each Peltier cell 25 has two opposing faces, 26 and 27; when subjected to a potential difference, it is configured in a known way to generate a temperature difference between the faces 26 and 27 in order to cause a flow of heat from the face 26, at a cooler temperature, towards the face 27, at a warmer temperature; the face 26 of the Peltier cell 25 is turned towards the passage 23, and is preferably arranged in such a position as to be directly exposed to the flow of air flowing through the passage 23.

In the example shown, the Peltier cells 25 are embedded in the walls 24, each with the face 27 turned towards the inside of the corresponding wall 24. Specifically, in each Peltier cell 25, the face 26 coincides with one of the two external faces of the corresponding wall 24. More specifically, each wall 24 comprises two Peltier cells 25, one on each of its external faces: for example, the configuration of each wall 24 is symmetrical with respect to a plane of symmetry extending radially with respect to the axis 22.

Specifically, each wall 24 has a frame 28, which surrounds and supports the two Peltier cells 25. The frames 28 of the walls 24 preferably consist of a single piece with the tubular body 21.

In each wall 24, the faces 27 of the two Peltier cells 25 are separated from each other, in a tangential direction, by an insert 29, which has the function of absorbing heat from the faces 27 and transferring it radially towards the tubular body 21 and thus to the outside. In other words, in use, the face 27 transmits heat (both that coming from the face 26, and that produced internally by the Peltier cell itself) by thermal conduction to the insert 29, and the latter, in turn, transfers heat by thermal conduction radially so that it can then be transferred to the external atmosphere surrounding the tubular body 21, essentially by unforced convection. Each insert 29 is preferably integral with a respective finned sector 30, arranged on an external surface 31 of the tubular body 21. The finned sector 30 receives heat from the insert 29 by thermal conduction and has multiple fins protruding cantilevered outwards, so as to increase the heat exchange surface area (and thus increase heat dissipation by convection) towards the external atmosphere.

According to a variant not illustrated, one or more Peltier cells 25 are embedded in the tubular body 21, with the face 26 arranged at an internal surface 32 radially delimiting the passage 23. In this case, the walls 24 may possibly be absent.

According to variants not illustrated, heat could be transferred by thermal conduction to the tubular body 21, and the latter could be directly fitted with fins for heat exchange with the external atmosphere (without fitting additional finned sectors 30).

The device 19 is preferably arranged coaxially with the impeller 11, so that the axis 22 shown in FIG. 3 coincides with the axis 13 in FIG. 2.

As shown in FIG. 2, for example, the tubular body 21 is defined by an end portion of the body 10; according to a different and preferred embodiment, not illustrated, the tubular body 21 may be defined by a piece that is distinct from the body 10 and is connected to the latter in a fixed position.

Still with reference to FIG. 2, at one end, the passage 23 ends at the inlet port 8 of the compressor 1 and, at the opposite end, communicates with the housing 12 through a duct 35, which is defined by a tubular portion 36 of the body 10 and represents a converging nozzle (converging in the direction of the air from the outlet of the passage 23 towards the inlet of the housing 12).

The diameter of the passage 23 is preferably constant; according to a variant not illustrated, the passage 23 could be convergent (that is, it could have a decreasing diameter, going towards the impeller 11) and possibly replace at least part of the duct 35.

In use, as mentioned above, when supplied by the wiring 20, the Peltier cells 25 remove heat from the combustive air sucked in, in order to cool it. This cooling reduces the volume of air treated by the compressor 1 and/or reduces the air temperature at the outlet port 9.

For example, thanks to the device 19 it is possible to reduce the heat exchange surface areas at the intercooler 3, other factors being equal. Otherwise, the device 19 makes it possible to proportionally increase the mass of air treated by the compressor 1 and entering the engine 2, to the benefit of the performance of the engine 2.

At the same time, the technique implemented to cool the combustive air by means of the device 19 does not involve the passage of a coolant, but is based on the Peltier effect, so the proposed solution is relatively simple to install. In particular, no specific modification to the body 10 is required. In fact, in the simplest embodiment, it may be sufficient to add the device 19 immediately in front of the portion 36 defining the duct 35 of an existing common compressor.

Moreover, the generation of the temperature difference, and thus the removal of heat from the air flowing through the passage 23, are almost immediate, as they are the direct consequences of an electrical potential difference (and not the consequence of a heat transfer fluid, which tends to take a relatively long time to remove heat).

From the above, finally, it is apparent that modifications and variations may be made to the compressor 1 described herein without departing from the scope of protection of the attached claims.

In particular, the shape and size of the passage 23, as well as the structure, shape and number of walls 24, may differ from what is shown as an example.

In addition, a fitting could be provided to connect the inlet of the duct 35 to the outlet of the passage 23 defined by the tubular body 2l.

1. A supercharging compressor for an internal combustion engine, comprising:
an inlet port,
an outlet port,
a support body,
an impeller coupled to the support body so as to rotate about an axis and configured so as to draw air from said inlet port and compress said air towards said outlet port when subjected to rotation;
a cooling device for cooling said air;
characterised in that said cooling device is a Peltier cell cooling device comprising at least one Peltier cell, that has a first face and a second face, opposite each other, and is powered by an electrical wiring to generate, in use, a difference in temperature between said first face and second face, and therefore a heat transfer from said first face to said second face; said first face faced towards a passage through which said air flows.

2. The supercharging compressor according to claim 1, wherein said first face is arranged at said passage so as to be directly exposed to said air during use.

3. The supercharging compressor according to claim 1, wherein said passage is arranged between said inlet port and said impeller.

4. The supercharging compressor according to claim 3, wherein said Peltier cell cooling device comprises a tubular body having an internal surface defining said passage and an external surface faced towards an external atmosphere; said second face being arranged in such a position as to transfer heat by thermal conduction towards said external surface.

5. The supercharging compressor according to claim 4, wherein said Peltier cell cooling device further comprises a plurality of fins that project outwardly from said external surface.

6. The supercharging compressor according to claim 3, wherein said support body defines a convergent duct arranged between said passage and said impeller.

7. The supercharging compressor according to claim 1, wherein said Peltier cell cooling device further comprises at least one wall arranged inside said passage; said Peltier cell being at least partially embedded in said wall.

8. The supercharging compressor according to claim 7, wherein said wall comprises two Peltier cells, arranged respectively at two external faces of said wall, opposite each other in the tangential direction.

9. The supercharging compressor according to claim 7, wherein said Peltier cell cooling device comprises a plurality of walls arranged inside said passage; each of said walls comprising at least one respective Peltier cell.

10. The supercharging compressor according to claim 1, wherein said passage has a constant diameter.
